(19) United States
(12) Patent Application Publication
(10) Pub. No.: US 2021/0029305 A1
(43) Pub. Date: Jan. 28, 2021

(54) METHOD AND APPARATUS FOR ADDING A VIDEO SPECIAL EFFECT, TERMINAL DEVICE AND STORAGE MEDIUM

(71) Applicant: BEIJING BYTEDANCE NETWORK TECHNOLOGY CO., LTD., Beijing (CN)

(72) Inventors: Tang TANG, Beijing (CN); Yu MENG, Beijing (CN); Manyi CHEN, Beijing (CN); Ye LIN, Beijing (CN); Ye CHEN, Beijing (CN)

(21) Appl. No.: 17/021,090

(22) Filed: Sep. 15, 2020

Related U.S. Application Data
(63) Continuation of application No. PCT/CN2019/097094, filed on Jul. 22, 2019.

(30) Foreign Application Priority Data
Nov. 29, 2018 (CN) 201811447962.6

(51) Int. Cl. H04N 5/262; G06K 9/00; H04N 5/232; H04N 5/77

(52) U.S. Cl. CPC H04N 5/2621; H04N 5/77; H04N 5/23293; G06K 9/00335

(57) ABSTRACT

Provided is a method for adding a video special effect. The method includes acquiring an image frame in a video, and recognizing a target human joint point of a user in the image frame; when a position of the target human joint point in the image frame satisfies a joint position condition, using the image frame as a target image frame and acquiring at least two consecutive image frames before the target image frame; determining a motion state of the target human joint point according to the target human joint point recognized in the at least two consecutive image frames; when the target human joint point satisfies a joint motion condition, acquiring a video special effect matching the video special effect condition; and adding, at a video position associated with the target image frame in the video, the video special effect matching the video special effect condition.

### CROSS REFERENCE TO RELATED APPLICATIONS

This is continuation of International Patent Application No. PCT/CN2019/097094, filed Jul. 22, 2019, which is based on and claims priority to Chinese Patent Application No. 201811447962.6 filed with the CNIPA on Nov. 29, 2018, the disclosures of which are incorporated herein by reference in their entireties.

### TECHNICAL FIELD

Embodiments of the present disclosure relate to data technology, for example, to a method and apparatus for adding a video special effect, a terminal device and a storage medium.

### BACKGROUND

With the development of communication technology and terminal devices, various terminal devices such as mobile phones and tablet computers have become an indispensable part of people's work. Moreover, with the increasing popularity of terminal devices, video interactive applications have become a main channel of communication and entertainment.

Currently, a video interactive application can recognize the face of a user and add a static image to the head of the user (for example, add a headwear to the hair) or add a facial expression to cover the face of the user. This method of adding images is too limited. Meanwhile, this method is applicable to only a single type of application scenarios and thus cannot satisfy the diverse requirements of the user.

### SUMMARY

Embodiments of the present disclosure provide a method and apparatus for adding a video special effect, a terminal device and a storage medium.

In a first aspect, embodiments of the present disclosure provide a method for adding a video special effect. The method includes acquiring at least one image frame in a video, and recognizing at least one target human joint point of a user in the at least one image frame; in the case where a position of the at least one target human joint point in the at least one image frame satisfies a joint position condition in a preset video special effect condition, using the at least one image frame as a target image frame and acquiring at least two consecutive image frames before the target image frame; determining a motion state of the at least one target human joint point according to the at least one target human joint point recognized in the at least two consecutive image frames; in the case where the motion state of the at least one target human joint point satisfies a joint motion condition, matching the joint position condition, in the video special effect condition, acquiring a video special effect matching the video special effect condition; and adding, at a video position associated with the target image frame in the video, the video special effect matching the video special effect condition.

In a second aspect, embodiments of the present disclosure provide an apparatus for adding a video special effect. The apparatus includes a target human joint point recognition module, a joint position condition determination module, a joint point motion state detection module, a joint motion condition determination module and a video special effect adding module. The target human joint point recognition module is configured to acquire at least one image frame in a video, and recognize at least one target human joint point of a user in the at least one image frame. The joint position condition determination module is configured to, in the case where a position of the at least one target human joint point in the at least one image frame satisfies a joint position condition in a preset video special effect condition, use the at least one image frame as a target image frame and acquire at least two consecutive image frames before the target image frame. The joint point motion state detection module is configured to determine a motion state of the at least one target human joint point according to the at least one target human joint point recognized in the at least two consecutive image frames. The joint motion condition determination module is configured to, in the case where the motion state of the at least one target human joint point satisfies a joint motion condition, matching the joint position condition, in the video special effect condition, acquire a video special effect matching the video special effect condition. The video special effect adding module is configured to add, at a video position associated with the target image frame in the video, the video special effect matching the video special effect condition.

In a third aspect, embodiments of the present disclosure further provide a terminal device. The terminal device includes at least one processor, a memory, which is configured to store at least one program. The at least one program is configured to, when executed by the at least one processor, cause the at least one processor to perform the method for adding a video special effect provided by embodiments of the present disclosure.

In a fourth aspect, embodiments of the present disclosure further provide a computer-readable storage medium storing a computer program. The computer program is configured to, when executed by a processor, cause the processor to perform the method for adding a video special effect provided by embodiments of the present disclosure.

### BRIEF DESCRIPTION OF DRAWINGS

FIG. 1A is a flowchart of a method for adding a video special effect according to an embodiment of the present disclosure;

FIG. 1B is a schematic view illustrating human joint points according to an embodiment of the present disclosure;

FIG. 1C is a schematic view illustrating set position ranges according to an embodiment of the present disclosure;

FIG. 1D is another schematic view illustrating set position ranges according to an embodiment of the present disclosure;

FIG. 2A is a flowchart of a method for adding a video special effect according to an embodiment of the present disclosure;

FIG. 2B is a schematic view illustrating human joint points according to an embodiment of the present disclosure;

FIG. 2C is another schematic view illustrating human joint points according to an embodiment of the present disclosure;

FIG. 3 is a structure diagram of an apparatus for adding a video special effect according to an embodiment of the present disclosure; and

FIG. 4 is a structure diagram of a terminal device according to an embodiment of the present disclosure.

### DETAILED DESCRIPTION

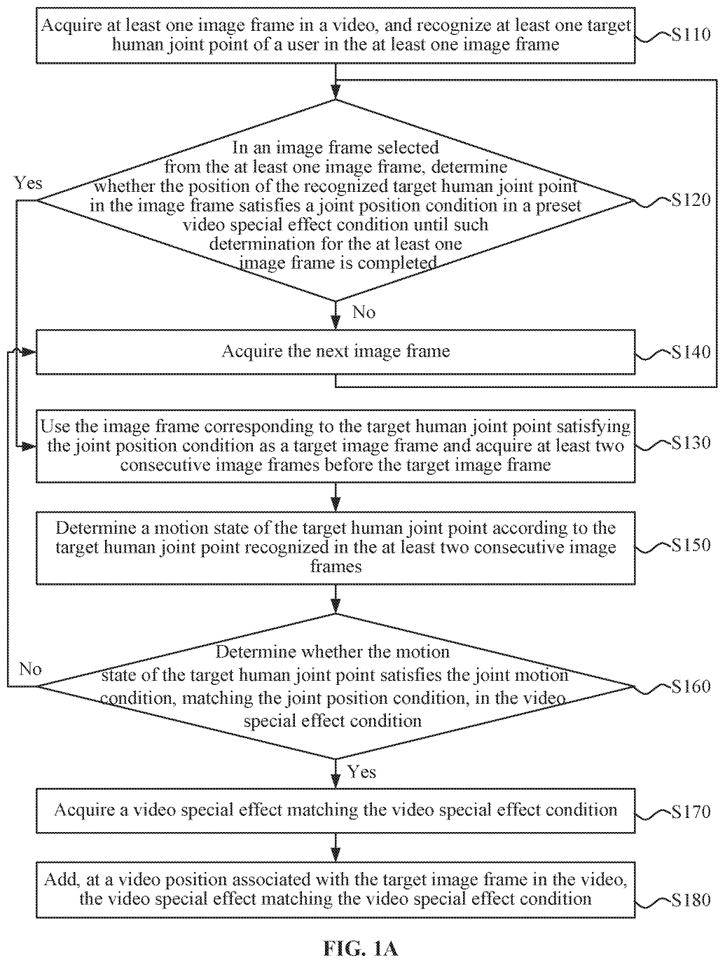

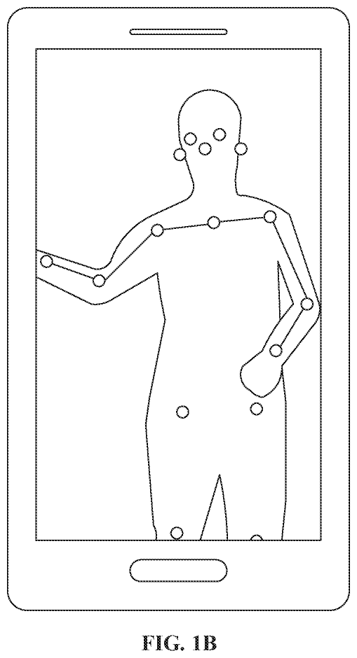

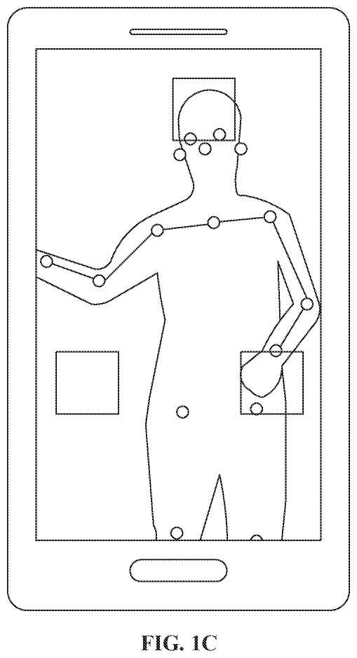

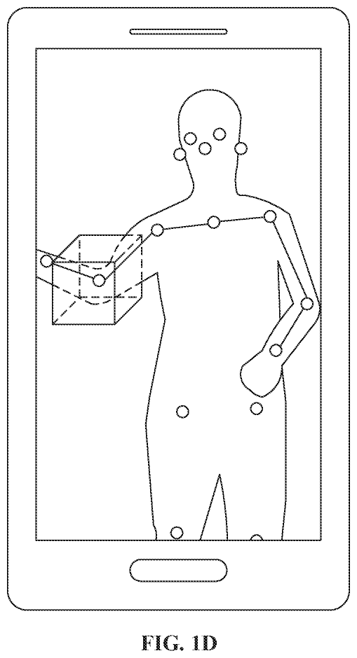

FIG. 1A is a flowchart of a method for adding a video special effect according to an embodiment of the present disclosure. This embodiment is applicable to a case where a video special effect is added in a video. The method may be performed by an apparatus for adding a video special effect. This apparatus may be implemented by at least one of software or hardware. This apparatus may be disposed in a terminal device, for example, typically a computer. As shown in FIG. 1A, the method includes step S110 to step S180.

In step S110, at least one image frame in a video is acquired, and at least one target human joint point of a user is recognized in the at least one image frame.

Generally, a video is formed by a series of static image frames consecutively projected at an extremely fast speed. Therefore, the video may be split into a series of image frames and an editing operation may be performed on the image frames so that the editing operation may be performed on the video. In the case where multiple users exist in the image frames, it is feasible to select, according to the recognition completeness and confidence of joint points of each user or according to the distance between each user and the device that shoots the video, one of the users to serve as the object to which a video special effect is to be added. Human joint points are used for determining the motion state of the user in the image frames, such as standing, bowing or jumping, and determining the position information of the user, such as the distance between the user and a terminal device, the position of the user relative to other objects shot by the terminal device, or the position of the user in the image shot by the terminal device.

In an example, as shown in FIG. 1B, in a mobile terminal, an outline of a human body is shown in the figure. The circles in the outline of the human body indicate recognized human joint points, and the connection line between two human joint points is used for indicating a body part of the human body. For example, the connection line between a wrist joint point and an elbow joint point is used for indicating the arm between a wrist and an elbow.

A human joint point recognition operation is performed on each image frame. First, all human body areas may be recognized in an image frame. For example, it is feasible to segment the image frame according to the depth information included in the image frame (the depth information may be acquired by an infrared camera) and recognize all human body areas in the image frame. One human body area is selected from all human body areas and is used for recognition of human joint points. For example, it is feasible to select, according to the distance from the human body area to the display screen of the terminal device, the human body area closest to the display screen of the terminal device to serve as a human body area in which human joint points of the user are required to be recognized. Furthermore, the determination is not limited to this method and may be performed using other methods. After the human body area is determined, human joint points in the human body area are recognized so that all human joint points belonging to the user are determined. Then, at least one target human joint point may be selected from all human joint points of the user according to requirements.

The method for recognizing human joint points may be determining body part areas (such as arms, hands, thighs and feet) belonging to the human body area in the human body area, calculating positions of joint points (such as elbows, wrists and knees) in each body part area, and generating, according to the position of each recognized joint point, a human skeleton system and determining at least one target human joint point from the a human skeleton system according to requirements. Furthermore, it is feasible to determine the motion state or position of a certain body part area of the user by using a connection line between two target human joint points (for example, the connection line between a wrist joint point and an elbow joint point is used for indicating the arm between a wrist and an elbow), for example, the vector of a line segment determined by two points formed by the coordinates of two target human joint points. All the preceding human body recognition, body part area recognition and calculation of positions of joint points in the body part area may be implemented by using a pre-trained deep learning model. The deep learning model may be trained according to depth features extracted from the depth information of the human body.

It is to be noted that human joint points may be recognized using other methods, and these methods are not limited in embodiments of the present disclosure.

In step S120, in an image frame selected from the at least one image frame, whether the position of the recognized target human joint point in the image frame satisfies a joint position condition in a preset video special effect condition is determined until such determination for the at least one image frame is completed. In the case where the position of the recognized target human joint point in the image frame satisfies the joint position condition in the preset video special effect condition, step S130 is performed; and in the case where the position of the recognized target human joint point in the image frame does not satisfy the joint position condition in the preset video special effect condition, step S140 is performed.

In an embodiment, positions of target human joint points recognized in all image frames in the video may be determined in a manner in which image frames are selected one by one according to the playback sequence of the video and then determination is performed.

The video special effect condition may refer to a condition used for addition of a video special effect and may include a joint position condition and a joint motion condition.

The joint position condition may refer to the position requirement of at least one target human joint point and is used for the operation of starting to add a video special effect, for example, placing the left hand at the center of an image shot by the camera. Alternatively, the joint position condition may refer to the relative-position requirement of two target human joint points, for example, placing the left hand in the area where the left eye joint point is located or in other areas. This is not limited in embodiments of the present disclosure.

The case where the target human joint point satisfies the preset joint position condition may mean that the target human joint point is constantly within the set position range or that the target human joint point enters or exits the set position range. In an embodiment, the set position range includes a set planar position range or a set spatial position range. The set planar position range may refer to a position range in a plane that is the same as or parallel to a video shooting plane. In the case where the position of a shot object that is mapped to the plane is within the set position range, it is determined that the object satisfies the set planar position range. The set spatial position range refers to the position range in the space shot in the video. In the case where a shot object is within the set spatial position range, it is determined that the object satisfies the set spatial position range. That is, the set planar position range does not include depth information while the set spatial position range includes the depth information. In an example, as shown in FIG. 1C, the three boxes are the set planar position range. As shown in FIG. 1D, the cube is the set spatial position range.

It is to be noted that one joint position condition corresponds to one set position range and corresponds to one video special effect. In the case where two joint position conditions exist, and each of two target human joint points satisfies a respective one of the set position ranges corresponding to the preceding two joint position conditions, two video special effects corresponding to the two joint position conditions may be added to the image frame simultaneously.

Furthermore, one joint position condition may also correspond to one target human joint point. For example, the target human joint point corresponding to a foot joint position condition is an ankle joint point rather than a wrist joint point, a head joint point or a shoulder joint point.

In step S130, the image frame corresponding to the target human joint point satisfying the joint position condition is used as a target image frame, at least two consecutive image frames before the target image frame are acquired, and then step S150 is performed.

In an embodiment, the at least two consecutive image frames may refer to n consecutive image frames, and n is greater than or equal to 2. The consecutiveness may mean that the video positions of the n consecutive image frames in the video are consecutive or that the playback sequence of the n consecutive image frames in the video is consecutive.

The case where the at least two consecutive image frames before the target image frame are acquired may mean that n consecutive image frames before the target image frame are acquired according to the playback sequence (or shooting sequence) of multiple image frames in the video. In fact, the two image frames, the three image frames or the n image frames before the target image frame are acquired. Meanwhile, the acquired image frames are consecutive.

In step S140, the next image frame is acquired, and then step S120 is performed.

In step S150, the motion state of the target human joint point is determined according to the target human joint point recognized in the at least two consecutive image frames.

In an embodiment, the at least one target human joint point is recognized in the at least two consecutive image frames respectively. The displacement of each target human joint point may be determined according to the position of each target human joint point in the at least two consecutive image frames. In an embodiment, the motion direction and motion distance of the target human joint point can be known according to the displacement of the target human joint point, and the motion speed of the target human joint point is determined according to the duration of the at least two consecutive image frames so that the motion state of the target human joint point is determined according to information such as the motion direction, motion distance and motion speed of the target human joint point. For example, it is determined, according to the position of the wrist joint point in each of 30 consecutive image frames, that a wrist joint point is consecutively translated to the right by 10 pixels.

In step S160, whether the motion state of the target human joint point satisfies the joint motion condition, matching the joint position condition, in the video special effect condition is determined. In the case where the motion state of the target human joint point satisfies the joint motion condition, matching the joint position condition, in the video special effect condition, step S170 is performed; and in the case where the motion state of the target human joint point does not satisfy the joint motion condition, matching the joint position condition, in the video special effect condition, step S140 is performed.

The joint motion condition may refer to the preset action of a joint point and include at least one of a motion direction, a motion speed or a motion distance. For example, a wrist moves down to a set area range; a wrist moves to the right at a speed of 1 pixel per frame; or multiple joint points (such as head, shoulder and elbow) move down, and meanwhile, the motion distance of the head joint point is greater than the motion distance of the shoulder joint point, and the motion distance of the shoulder joint point is greater than the motion distance of the elbow joint point. There are other actions, which are not limited in embodiments of the present disclosure.

It is to be noted that the video special effect condition includes multiple joint position conditions and multiple joint motion conditions as well as the correspondence relationship between the joint position conditions and the joint motion conditions. It is feasible to determine whether the target human joint point satisfies a joint motion condition after the target human joint point satisfies a joint position condition. For example, in response to determining that a user has a drumming action, whether a palm joint point of the user enters a drumhead area needs to be determined first. After it is determined that the palm joint point enters the drumhead area, it is determined whether a top-to-bottom motion state of the palm exists in multiple consecutive image frames before the current image frame. If the top-to-bottom motion state of the palm exists in multiple consecutive image frames before the current image frame, it is determined that the palm joint point of the user has an action of hitting the drumhead area so that the music effect and the animation effect corresponding to the drumhead being hit may be added correspondingly.

In step S170, a video special effect matching the video special effect condition is acquired.

In the video, a video special effect matching the video special effect condition is added from the current image frame satisfying the video special effect condition. The video special effect is used for adding a special effect matching the user action to the target image frame to achieve user interaction. For example, the video special effect may refer to at least one of an animation special effect or a music special effect. The animation special effect is added such that at least one of a static image or a dynamic image is drawn in the target image frame being displayed to cover the original content of the target image frame. The music special effect is added such that a piece of music is played in the target image frame being displayed.

In step S180, at a video position associated with the target image frame in the video, the video special effect matching the video special effect condition is added.

The video position is used for indicating the position of an image frame in the video. Because the image frames split from the video may be arranged in accordance with the video playback sequence, the video position may also be used for indicating the playback moment of the image frame during the video playback process. The playback moment may refer to a moment relative to the starting moment of the video playback. A series of image frames split from the video may be numbered according to the playback sequence. For example, the first played image frame is the first frame, the image frame played after the first image frame is the second frame, and so forth. By such analogy, all the image frames split from the video are numbered. For example, the video may be split into 100 frames, each image frame corresponds to a serial number, and the target image frame may be the 50th frame.

After the video position of the target image frame is determined, a video special effect is added at the video position. In fact, the video special effect may be expressed in the form of codes. The video special effect is added at the video position, that is, a code fragment corresponding to the video special effect is added to a code fragment corresponding to the target image frame so that the video special effect is added to the target image frame.

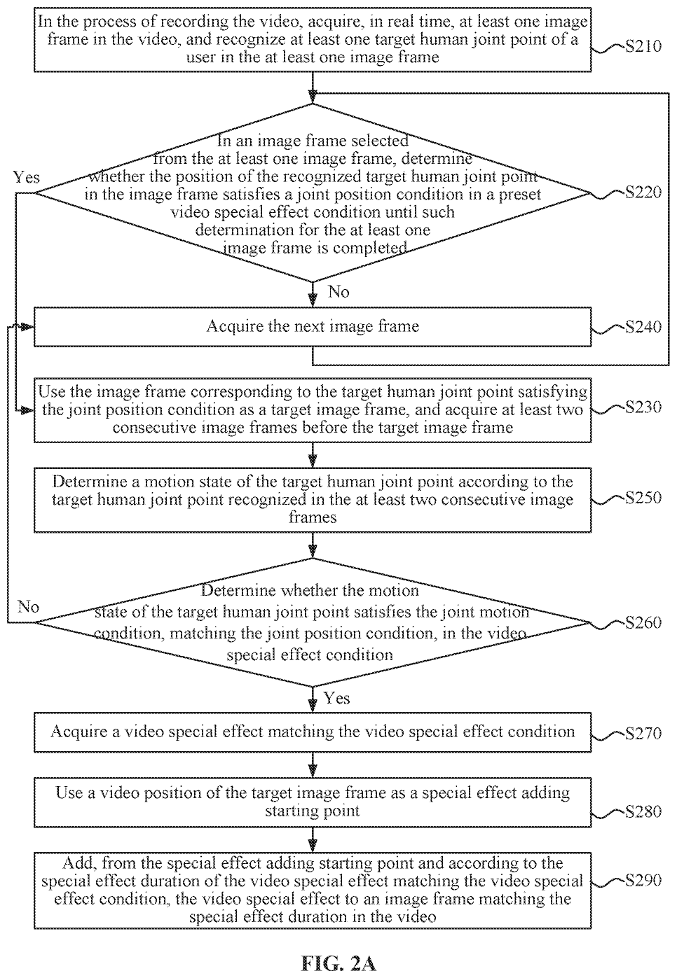

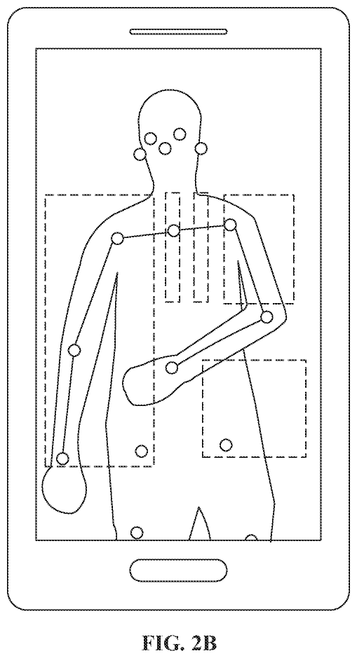

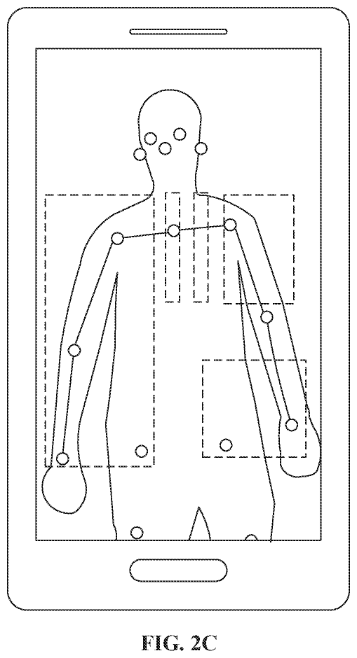

In embodiments of the present disclosure, in the case where the target human joint point recognized in the image frame of a video satisfies a joint position condition in the video special effect condition and a joint motion condition matching the joint position condition, a motion special effect matching the video special effect condition is added to the video. In this manner, a video interactive application is prevented from having only a single video special effect, a video special effect can be added according to the position and motion state of a joint point of a user, the richness of a video interactive application is increased, and the flexibility in adding a special effect to a video is increased. FIG. 2A is a flowchart of a method for adding a video special effect according to an embodiment of the present disclosure. This embodiment is refined based on the solutions in the preceding embodiments. In this embodiment, the case where at least one image frame in the video is acquired is refined into: at least one image frame in the video is acquired in real time in the process of recording the video. Meanwhile, the case where at the video position associated with the target image frame in the video, the video special effect matching the joint position condition is added is refined into: the video position of the target image frame is used as a special effect adding starting point; the video special effect is added, from the special effect adding starting point and according to the special effect duration of the video special effect matching the video special effect condition, to image frames matching the special effect duration in the video.

Correspondingly, the method of this embodiment may include step S210 to step S290.

In step S210, at least one image frame in the video is acquired, in real time, in the process of recording the video, and at least one target human joint point of a user is recognized in the at least one image frame.

The video may be shot in real time and each image frame in the video is acquired in real time.

For details about the video, image frame, target human joint point, video special effect condition, joint position condition, joint motion condition, video position, video special effect and so on in this embodiment, the description in the preceding embodiments can be referred to.

In step S220, in an image frame selected from the at least one image frame, whether the position of the recognized target human joint point in the image frame satisfies a joint position condition in a preset video special effect condition is determined until such determination for the at least one image frame is completed. In the case where the position of the recognized target human joint point in the image frame satisfies the joint position condition in the preset video special effect condition, step S230 is performed; and in the case where the position of the recognized target human joint point in the image frame does not satisfy the joint position condition in the preset video special effect condition, step S240 is performed.

In step S230, the image frame corresponding to the target human joint point satisfying the joint position condition is used as a target image frame, at least two consecutive image frames before the target image frame are acquired, and then step S250 is performed.

In an embodiment, the step in which the motion state of the target human joint point is determined according to the recognized target human joint point in the at least two consecutive image frames may include that the motion state of the target human joint point is determined according to the video positions associated with the at least two consecutive image frames in the video and the position of the target human joint point in the at least two consecutive image frames.

For example, according to the video positions associated with the at least two consecutive image frames in the video, the time sequence of the at least two consecutive image frames during the video playback process may be determined. According to the position of the target human joint point in the at least two consecutive image frames, the motion direction and motion distance of the target human joint point in any two adjacent consecutive image frames are determined, and then the motion direction and motion distance of the target human joint point in a video segment formed by the at least two consecutive image frames are determined, so that the motion state of the target human joint point is determined.

In an embodiment, the step in which it is determined that the motion state of the target human joint point satisfies the joint motion condition, matching the joint position condition, in the video special effect condition may include in the case where a change direction of the position of the target human joint point in the at least two consecutive image frames satisfies a change direction in the joint motion condition, determining that the motion state of the target human joint point satisfies the joint motion condition.

For example, according to the position of the target human joint point in the at least two consecutive image frames, the position may be coordinate information used for determining the change direction of the target human joint point in the at least two consecutive image frames. In an example, the position of the target human joint point in the at least two consecutive image frames gradually moves from the coordinates (x1, y1) to the coordinates (x2, y2), and the change direction of the position of the target human joint point is the direction from the coordinates (x1, y1) to the coordinates (x2, y2).

Furthermore, in general, the position of the target human joint point in at least two consecutive image frames consecutively changes with the time sequence. However, the target human joint point recognized in each of the consecutive image frames has errors. Suddenly changing or discrete positions that are recognized may be regarded as errors and eliminated. Consecutively changing positions of the target human joint point in the at least two consecutive image frames are retained and used as the basis for determining a position change direction.

In an embodiment, the step in which the position of the recognized target human joint point in the image frame satisfies the joint position condition in the preset video special effect condition includes in the case where the position of the target human joint point in the image frame is within a set position range matching the joint position condition and the position of the target human joint point in a previous image frame of the image frame is not within the set position range, determining the image frame as a target image frame and determining that the target human joint frame recognized in the target image frame satisfies the joint position condition.

For example, the entry state of the target human joint point entering the set position range is used as a preset joint position condition. In the case where the target human joint point is within the set position range in the current image frame and is not within the set position range in a previous image frame of the current image frame, it is determined that the target human joint point enters the set position range from outside the set position range, it is determined that the target human joint point has an entry state for the set position range, and then it is determined that the target human joint point satisfies the preset joint position condition. In an example, as shown in FIG. 2B and FIG. 2C, the set position ranges are 5 dotted rectangles. The dimensions of these 5 rectangular areas may not be all the same. Correspondingly, the video special effects corresponding to these 5 rectangular areas may be the same or may not be all the same. The left wrist joint point in FIG. 2B is outside the set position ranges, and the left wrist joint point in FIG. 2C is within the set position ranges. In the case where the position of the left wrist joint point of the user is changed from the position shown in FIG. 2B to the position shown in FIG. 2C, it is determined that the left wrist joint point of the user enters the set position ranges from outside the set position ranges, and then it is determined that the left wrist joint point of the user satisfies the preset joint position condition.

In step S240, the next image frame is acquired, and then step S220 is performed.

In step S250, the motion state of the target human joint point is determined according to the target human joint point recognized in at least two consecutive image frames.

In step S260, whether the motion state of the target human joint point satisfies the joint motion condition, matching the joint position condition, in the video special effect condition is determined. In the case where the motion state of the target human joint point satisfies the joint motion condition, matching the joint position condition, in the video special effect condition, step S270 is performed; and in the case where the motion state of the target human joint point does not satisfy the joint motion condition, matching the joint position condition, in the video special effect condition, step S240 is performed.

In step S270, a video special effect matching the video special effect condition is acquired.

In step S280, a video position of the target image frame is used as a special effect adding starting point.

Because the video position may be used for indicating the position of the image frame in the video, the special effect adding starting point may refer to the starting position where the video special effect is added.

In step S290, the video special effect is added, from the special effect adding starting point and according to the special effect duration of the video special effect matching the video special effect condition, to an image frame matching the special effect duration in the video.

The special effect duration may refer to the passed time between the starting position and the ending position of the video special effect. The image frame matching the special effect duration may refer to all image frames from the special effect adding starting point in the video, that is, from the target image frame, to the corresponding ending image frame when the video special effect ends. For example, the video special effect is a music special effect. If the duration of one music special effect is 3 s and 30 image frames are played in the video per second, then 90 image frames from the target image frame (including the target image frame) according to the video playback sequence are the image frames matching the special effect duration.

In embodiments of the present disclosure, a video is shot in real time, and a series of image frames split from the video are acquired in real time so that whether the target human joint point of the user in the shot video satisfies the joint position condition in the video special effect condition and the joint motion condition matching the joint position condition is determined in real time. Moreover, in the case where the target human joint point of the user in the shot video satisfies the video special effect condition, a video special effect is added in real time. In this manner, the video special effect can be added while the video is recorded, and the efficiency of adding the video special effect is improved.

Based on the preceding embodiments, in an embodiment, the method for adding a video special effect further includes displaying image frames in the video on a video preview interface in real time in the process of recording the video; during the operation of adding the video special effect to the image frames matching the special effect duration in the video, the method further includes displaying, on the video preview interface in real time, the image frames to which the video special effect is added.

The video preview interface may refer to an interface of a terminal device used for a user to view a video. The terminal device may include a server device or a client device. While the video is shot in real time, the video is displayed on the video preview interface in real time so that the user can view the content of the captured video in real time.

While the video special effect is added in real time, the video special effect and the video are displayed on the video preview interface so that the user can view, in real time, the video to which the video effect is added, the efficiency of adding the video special effect is improved, and the user experience is improved.

In an embodiment, the video special effect includes at least one of a dynamic animation special effect or a music special effect; displaying, on the video preview interface in real time, the image frame to which the video special effect is added includes drawing the dynamic animation special effect in the image frames of the video on the video preview interface in real time, and playing the music special effect.

For example, in the case where the video special effect includes the dynamic animation special effect, the dynamic animation special effect is drawn in the image frame displayed in real time. For example, at least one image of an instrument, a background or a human figure is drawn. In the case where the video special effect includes the music special effect, the music special effect is played while the image frames are displayed in real time. The video special effect includes at least one of the dynamic animation special effect or the music special effect so that the diversity of video special effects is improved.

In an example, the user selects a drumming scene and starts to record a video, and the recorded video and the added special effects are presented to the user in real time through the video preview interface. According to the initial motion posture of the user, the animation effect of a drum is rendered at the lower limbs of the user in the video. In the case where the left palm joint point of the user falls onto the drumhead area from the top down, the animation effect of the drumhead being hit is rendered in the video. For example, in the case where the left palm joint point falls onto the drumhead area, the drumhead presents a concave shape and meanwhile the sound effect of drumming is played.

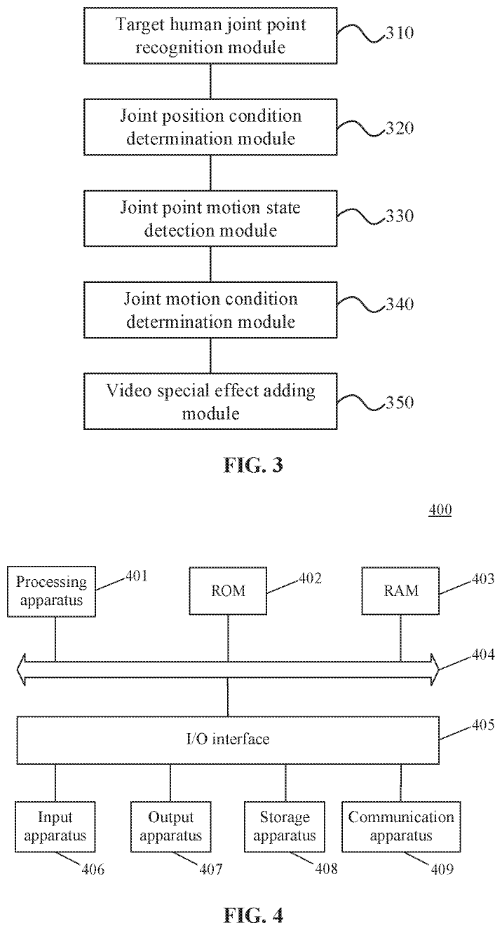

In another example, the user selects the scene of a dance mat (such as a Sudoku dance mat) and starts to record a video. According to the initial motion posture of the user, the animation effect of the dance mat is rendered in the foot area of the user in the video. In the case where the right ankle joint point of the user falls into the middle grid area of the dance mat from the top down, the animation effect of treading is rendered in the middle grid area of the dance mat in the video. For example, in the case where the right ankle joint point falls into the middle grid area of the dance mat, the upper half of the area presents the shape of a smoke ring spreading outward while the sound effect corresponding to the middle grid of the dance mat is played. FIG. 3 is a structure diagram of an apparatus for adding a video special effect according to an embodiment of the present disclosure. This embodiment is applicable to a case where a video special effect is added in a video. This apparatus may be implemented by at least one of software or hardware. This apparatus may be disposed in a terminal device. As shown in FIG. 3, this apparatus may include a target human joint point recognition module 310, a joint position condition determination module 320, a joint point motion state detection module 330, a joint motion condition determination module 340 and a video special effect adding module 350.

The target human joint point recognition module 310 is configured to acquire at least one image frame in a video, and recognize at least one target human joint point of a user in the at least one image frame.

The joint position condition determination module 320 is configured to, in the case where a position of the at least one recognized target human joint point in the at least one image frame satisfies a joint position condition in a preset video special effect condition, use the at least one image frame as a target image frame and acquire at least two consecutive image frames before the target image frame.

The joint point motion state detection module 330 is configured to determine a motion state of the at least one target human joint point according to the at least one target human joint point recognized in the at least two consecutive image frames.

The joint motion condition determination module 340 is configured to, in the case where the motion state of the at least one target human joint point satisfies a joint motion condition, matching the joint position condition, in the video special effect condition, acquire a video special effect matching the video special effect condition.

The video special effect adding module 350 is configured to add, at a video position associated with the target image frame in the video, the video special effect matching the video special effect condition.

In embodiments of the present disclosure, in the case where the target human joint point recognized in the image frame of a video satisfies a joint position condition in the video special effect condition and a joint motion condition matching the joint position condition, a motion special effect matching the video special effect condition is added to the video. In this manner, a video interactive application is prevented from having only a single video special effect, a video special effect can be added according to the position and motion state of a joint point of a user, the richness of a video interactive application is increased, and the flexibility in adding a special effect to a video is increased.

In an embodiment, the target human joint point recognition module 310 includes an image frame real-time acquisition module. The image frame real-time acquisition module is configured to acquire the at least one image frame in the video in real time in the process of recording the video. The video special effect adding module 350 includes a special effect adding starting-point determination module and a video special effect real-time adding module. The special effect adding starting-point determination module is configured to use the video position of the target image frame as a special effect adding starting point. The video special effect real-time adding module is configured to add, from the special effect adding starting point and according to the special effect duration of a video special effect matching the joint position condition, the video special effect to image frames matching the special effect duration in the video.

In an embodiment, the joint point motion state detection module includes a motion state determination module. The motion state determination module is configured to determine the motion state of the at least one target human joint point according to video positions associated with the at least two consecutive image frames in the video and positions of the at least one target human joint point in the at least two consecutive image frames.

In an embodiment, the joint motion condition determination module 340 includes a position change direction detection module. The position change direction detection module is configured to, in the case where a change direction of the positions of the at least one target human joint point in the at least two consecutive image frames satisfies a change direction in the joint motion condition, determine that the motion state of the at least one target human joint point satisfies the joint motion condition.

In an embodiment, the joint position condition determination module 320 includes a position detection module. The position detection module is configured to, in the case where the position of the at least one target human joint point in the at least one image frame is within a set position range matching the joint position condition and a position of the at least one target human joint point in a previous image frame of the at least one image frame is not within the set position range, determine the at least one image frame as the target image frame and determine that the at least one target human joint point recognized in the target image frame satisfies the joint position condition.

In an embodiment, the apparatus for adding a video special effect further includes an image frame real-time display module and a video special effect real-time display module. The image frame real-time display module is configured to display image frames in the video on a video preview interface in real time in the process of recording the video. The video special effect real-time display module is configured to display, on the video preview interface in real time, the image frames to which the video special effect is added.

In an embodiment, the video special effect includes at least one of a dynamic animation special effect or a music special effect. The video special effect real-time display module includes a special effect showing and playing module. The special effect showing and playing module is configured to draw the dynamic animation special effect in real time, and play the music special effect.

The apparatus for adding a video special effect provided by embodiments of the present disclosure belongs to the same inventive concept as the preceding method for adding a video special effect. For technical details not described in detail in embodiments of the present disclosure, the preceding method for adding a video special effect may be used as a reference.

Embodiments of the present disclosure provide a terminal device. Referring to FIG. 4, FIG. 4 shows a structure diagram of an electronic device (such as a client or a server) 400 applicable to implementing embodiments of the present disclosure. The terminal device in embodiments of the present disclosure may include, but is not limited to, mobile terminals such as a mobile phone, a laptop, a digital broadcast receiver, a personal digital assistant (PDA), a portable Android device (PAD), a portable media player (PMP) and an in-vehicle terminal (such as an in-vehicle navigation terminal), and stationary terminals such as a digital television (TV) and a desktop computer. The electronic device shown in FIG. 4 is merely an example and should not impose any limitation on the functionality and scope of use of embodiments of the present disclosure.

As shown in FIG. 4, the electronic device 400 may include a processing apparatus (such as a central processing unit, a graphics processing unit) 401. The processing apparatus 401 may execute, according to a program stored in a read-only memory (ROM) 402 or a program loaded into a random access memory (RAM) 403 from a storage apparatus 408, various appropriate actions and processing. In the RAM 403, various programs and data required for the operation of the electronic device 400 are also stored. The processing apparatus 401, the ROM 402, and the RAM 403 are connected to each other through a bus 404. An input/output (I/O) interface 405 is also connected to the bus 404.

Generally, the following apparatus may be connected to the I/O interface 405: including input apparatuses 406 such as a touch screen, a touch pad, a keyboard, a mouse, a camera, a microphone, an accelerometer and a gyroscope; including output apparatuses 407 such as a liquid crystal display (LCD), a speaker and a vibrator; including storage apparatuses 408 such as a magnetic tape and a hard disk; and a communication apparatus 409. The communication apparatus 409 allows the electronic device 400 to perform wireless or wired communication with other devices to exchange data. Although FIG. 4 shows the electronic device 400 having various apparatuses, it is to be understood that it is not required to implement or have all the shown apparatuses. The electronic device 400 may be alternatively implemented or provided with more or fewer apparatuses.

According to embodiments of the present disclosure, the process described above with reference to the flowchart may be implemented as a computer software program. For example, embodiments of the present disclosure include a computer program product. The computer program product includes a computer program carried on a computer-readable medium, and the computer program includes program codes for performing the method shown in the flowchart. In these embodiments, the computer program may be downloaded from the network through the communication apparatus 409 and then installed, or may be installed from the storage apparatus 408, or may be installed from the ROM 402. When the computer program is executed by the processing apparatus 401, the preceding functions defined in the methods of embodiments of the present disclosure are executed.

Embodiments of the present disclosure further provide a computer-readable storage medium. The computer-readable medium may be a computer-readable signal medium, a computer-readable storage medium or any combination of the two. The computer-readable storage medium may be, but is not limited to, an electrical, magnetic, optical, electromagnetic, infrared or semiconductor system, apparatus or device or any combination thereof. Specifically, the computer-readable storage medium may include, but is not limited to, an electrical connection having one or more wires, a portable computer disk, a hard disk, a random access memory (RAM), a read-only memory (ROM), an erasable programmable read-only memory (EPROM) or flash memory, an optical fiber, a portable compact disc read-only memory (CD-ROM), an optical memory device, a magnetic memory device, or any suitable combination thereof. In the present disclosure, the computer-readable storage medium may be any tangible medium including or storing a program. The program may be used by or used in conjunction with an instruction execution system, apparatus or device. In the present disclosure, the computer-readable signal medium may include a data signal propagated on a base band or as a part of a carrier wave. The data signal carries computer-readable program codes. This propagated data signal may take multiple forms including, but not limited to, an electromagnetic signal, an optical signal, or any suitable combination thereof. The computer-readable signal medium may further be any computer-readable medium other than a computer-readable storage medium. The computer-readable signal medium may send, propagate or transmit a program used by or used in conjunction with an instruction execution system, apparatus or device. The program codes included in the computer-readable medium may be transmitted in any suitable medium, including, but not limited to, a wire, an optical cable, a radio frequency (RF), or any suitable combination thereof.

The preceding computer-readable medium may be included in the preceding electronic device, or may exist alone without being assembled into the electronic device.

The preceding computer-readable medium carries at least one program, and when executed by the electronic device, the preceding at least one program causes the electronic device to acquire at least one image frame in a video, and recognize at least one target human joint point of a user in the at least one image frame; in the case where a position of the at least one recognized target human joint point in the at least one image frame satisfies a joint position condition in a preset video special effect condition, use the at least one image frame as a target image frame and acquire at least two consecutive image frames before the target image frame; determine a motion state of the at least one target human joint point according to the at least one target human joint point recognized in the at least two consecutive image frames; in the case where the motion state of the at least one target human joint point satisfies a joint motion condition, matching the joint position condition, in the video special effect condition, acquire a video special effect matching the video special effect condition; and add, at a video position associated with the target image frame in the video, the video special effect matching the video special effect condition.

Computer program codes for performing the operations of the present disclosure may be written in one or more programming languages or combination thereof. The preceding one or more programming languages include object-oriented programming languages such as Java, Smalltalk, C++, as well as conventional procedural programming languages such as “C” or similar programming languages. The program codes may be executed entirely or partially on a user computer, as a separate software package, partially on the user computer and partially on a remote computer, or entirely on the remote computer or server. In the case relating to the remote computer, the remote computer may be connected to the user computer via any kind of networks including a local area network (LAN) or a wide area network (WAN), or may be connected to an external computer (for example, via the Internet through an Internet service provider).

The flowcharts and block diagrams in the drawings show the possible architecture, functions and operations of the system, method and computer program product according to various embodiments of the present disclosure. In this regard, each block in the flowcharts or block diagrams may represent a module, a program segment or part of codes that includes one or more executable instructions for implementing specified logical functions. It is also to be noted that, in some alternative implementations, the functions noted in the blocks may take an order different than noted in the drawings. For example, two sequential blocks may, in fact, be executed substantially concurrently, or sometimes executed in the reverse order, which depends on the involved functions. It is also to be noted that each block of the block diagrams and/or flowcharts, and combinations of blocks in the block diagrams and/or flowcharts may be implemented by not only specific-purpose hardware-based systems that perform specified functions or actions, but also combinations of specific-purpose hardware and computer instructions.

The modules involved and described in embodiments of the present disclosure may be implemented in software or hardware. The names of the modules do not constitute a limitation on the modules themselves under certain circumstances. For example, the target human joint point recognition module may also be described as “a module acquiring at least one image frame in a video and recognizing at least one target human joint point of a user in the at least one image frame”.

What is claimed is:

1. A method for adding a video special effect, comprising:
acquiring an image frame in a video, and recognizing a target human joint point of a user in the image frame;
in a case where a position of the target human joint point in the image frame satisfies a joint position condition in a preset video special effect condition, using the image frame as a target image frame and acquiring at least two consecutive image frames before the target image frame;
determining a motion state of the target human joint point according to the target human joint point recognized in the at least two consecutive image frames;
in a case where the motion state of the target human joint point satisfies a joint motion condition, matching the joint position condition, in the video special effect condition, acquiring a video special effect matching the video special effect condition; and
adding, at a video position associated with the target image frame in the video, the video special effect matching the video special effect condition.

2. The method of claim 1, wherein acquiring the image frame in the video comprises: acquiring the image frame in the video in real time in a process of recording the video; and
wherein adding, at the video position associated with the target image frame in the video, the video special effect matching the video special effect condition comprises:
using a video position of the target image frame as a special effect adding starting point; and
adding, from the special effect adding starting point and according to special effect duration of the video special effect matching the video special effect condition, the video special effect to image frames matching the special effect duration in the video.

3. The method of claim 2, wherein determining the motion state of the target human joint point according to the target human joint point recognized in the at least two consecutive image frames comprises:
determining the motion state of the target human joint point according to video positions associated with the at least two consecutive image frames in the video and positions of the target human joint point in the at least two consecutive image frames.

4. The method of claim 3, wherein the case where the motion state of the target human joint point satisfies the joint motion condition, matching the joint position condition, in the video special effect condition comprises:
in a case where a change direction of the positions of the target human joint point in the at least two consecutive image frames satisfies a change direction in the joint motion condition, determining that the motion state of the target human joint point satisfies the joint motion condition.

5. The method of claim 2, wherein the case where the position of the target human joint point in the image frame satisfies the joint position condition in the preset video special effect condition comprises:
in a case where the position of the target human joint point in the image frame is within a set position range matching the joint position condition and a position of the target human joint point in a previous image frame of the image frame is not within the set position range, determining the image frame as the target image frame and determining that the target human joint point recognized in the target image frame satisfies the joint position condition.

6. The method of claim 2, wherein the method further comprises:
displaying image frames in the video on a video preview interface in real time in the process of recording the video; and
wherein during the operation of adding the video special effect to the image frames matching the special effect duration in the video, the method further comprises:
displaying, on the video preview interface in real time, the image frames to which the video special effect is added.

7. The method of claim 3, wherein the method further comprises:
displaying image frames in the video on a video preview interface in real time in the process of recording the video; and
wherein during the operation of adding the video special effect to the image frames matching the special effect duration in the video, the method further comprises:
displaying, on the video preview interface in real time, the image frames to which the video special effect is added.

8. The method of claim 4, wherein the method further comprises:
displaying image frames in the video on a video preview interface in real time in the process of recording the video; and
wherein during the operation of adding the video special effect to the image frames matching the special effect duration in the video, the method further comprises:
displaying, on the video preview interface in real time, the image frames to which the video special effect is added.

9. The method of claim 5, wherein the method further comprises:
displaying image frames in the video on a video preview interface in real time in the process of recording the video; and
wherein during the operation of adding the video special effect to the image frames matching the special effect duration in the video, the method further comprises:
displaying, on the video preview interface in real time, the image frames to which the video special effect is added.

10. The method of claim 6, wherein the video special effect comprises at least one of a dynamic animation special effect or a music special effect; and
wherein displaying, on the video preview interface in real time, the image frames to which the video special effect is added comprises:
drawing the dynamic animation special effect in the image frames of the video on the video preview interface in real time, and playing the music special effect.

11. A terminal device, comprising:
at least one processor; and
a memory, configured to store at least one program;
wherein the at least one program is configured to, when executed by the at least one processor, cause the at least one processor to perform the following steps:
acquiring an image frame in a video, and recognizing a target human joint point of a user in the image frame;
in a case where a position of the target human joint point in the image frame satisfies a joint position condition in a preset video special effect condition, using the image frame as a target image frame and acquiring at least two consecutive image frames before the target image frame;
determining a motion state of the target human joint point according to the target human joint point recognized in the at least two consecutive image frames;
in a case where the motion state of the target human joint point satisfies a joint motion condition, matching the joint position condition, in the video special effect condition, acquiring a video special effect matching the video special effect condition; and
adding, at a video position associated with the target image frame in the video, the video special effect matching the video special effect condition.

12. The terminal device of claim 11, wherein the at least one program is configured to cause the at least one processor to acquire the image frame in the video by acquiring the image frame in the video in real time in a process of recording the video; and
wherein the at least one program is configured to cause the at least one processor to add, at the video position associated with the target image frame in the video, the video special effect matching the video special effect condition by:
using a video position of the target image frame as a special effect adding starting point; and
adding, from the special effect adding starting point and according to special effect duration of the video special effect matching the video special effect condition, the video special effect to image frames matching the special effect duration in the video.

13. The terminal device of claim 12, wherein the at least one program is configured to cause the at least one processor to determine the motion state of the target human joint point according to the target human joint point recognized in the at least two consecutive image frames by:
determining the motion state of the target human joint point according to video positions associated with the at least two consecutive image frames in the video and positions of the target human joint point in the at least two consecutive image frames.

14. The terminal device of claim 13, wherein the case where the motion state of the target human joint point satisfies the joint motion condition, matching the joint position condition, in the video special effect condition comprises: the at least one processor is configured to:
in a case where a change direction of the positions of the target human joint point in the at least two consecutive image frames satisfies a change direction in the joint motion condition, determine that the motion state of the target human joint point satisfies the joint motion condition.

15. The terminal device of claim 12, wherein the case where the position of the target human joint point in the image frame satisfies the joint position condition in the preset video special effect condition comprises: the at least one processor is configured to:
in a case where the position of the target human joint point in the image frame is within a set position range matching the joint position condition and a position of the target human joint point in a previous image frame of the image frame is not within the set position range, determine the image frame as the target image frame and determine that the target human joint point recognized in the target image frame satisfies the joint position condition.

16. The terminal device of claim 12, wherein the at least one program is configured to cause the at least one processor to further perform the following steps:
displaying image frames in the video on a video preview interface in real time in the process of recording the video; and
during the operation of adding the video special effect to the image frames matching the special effect duration in the video, displaying, on the video preview interface in real time, the image frames to which the video special effect is added.

17. The terminal device of claim 13, wherein the at least one program is configured to cause the at least one processor to further perform the following steps:
displaying image frames in the video on a video preview interface in real time in the process of recording the video; and
during the operation of adding the video special effect to the image frames matching the special effect duration in the video, displaying, on the video preview interface in real time, the image frames to which the video special effect is added.

18. The terminal device of claim 14, wherein the at least one program is configured to cause the at least one processor to further perform the following steps:
displaying image frames in the video on a video preview interface in real time in the process of recording the video; and
during the operation of adding the video special effect to the image frames matching the special effect duration in the video, displaying, on the video preview interface in real time, the image frames to which the video special effect is added.

19. The terminal device of claim 16, wherein the video special effect comprises at least one of a dynamic animation special effect or a music special effect; and
wherein the at least one program is configured to cause the at least one processor to display, on the video preview interface in real time, the image frames to which the video special effect is added by:
drawing the dynamic animation special effect in the image frames of the video on the video preview interface in real time, and playing the music special effect.

20. A non-transitory computer-readable storage medium, storing a computer program, wherein the computer program is configured to, when executed by a processor, cause the processor to perform the following steps:
acquiring an image frame in a video, and recognizing a target human joint point of a user in the image frame;
in a case where a position of the target human joint point in the image frame satisfies a joint position condition in a preset video special effect condition, using the image frame as a target image frame and acquiring at least two consecutive image frames before the target image frame;
determining a motion state of the target human joint point according to the target human joint point recognized in the at least two consecutive image frames;
in a case where the motion state of the target human joint point satisfies a joint motion condition, matching the joint position condition, in the video special effect condition, acquiring a video special effect matching the video special effect condition; and
adding, at a video position associated with the target image frame in the video, the video special effect matching the video special effect condition.
